(19) United States
(12) Patent Application Publication
(10) Pub. No.: US 2023/0344320 A1
(43) Pub. Date: Oct. 26, 2023

(54) POWER CONVERSION DEVICE

(71) Applicant: FUJI ELECTRIC CO., LTD., Kawasaki-shi (JP)

(72) Inventor: Toshiaki AZUMA, Amagasaki-shi (JP)

(21) Appl. No.: 18/297,810

(22) Filed: Apr. 10, 2023

(30) Foreign Application Priority Data
Apr. 25, 2022 (JP) 2022-071940

(51) Int. Cl. H02K 11/33; H02M 1/00; H02M 7/00; H02M 7/537; H02K 3/50; H02K 11/27

(52) U.S. Cl. CPC H02K 11/33; H02M 1/0009; H02M 7/003; H02M 7/537; H02K 3/50; H02K 11/27; H02K 2203/09; H02K 2211/03

(57) ABSTRACT

A power conversion device includes a power converter, a power converter housing, an output terminal, a current sensor, and a terminal block. The current sensor includes a current sensor main body and a current sensor housing to house the current sensor main body. The terminal block is provided on the current sensor housing.

### CROSS-REFERENCE TO RELATED APPLICATION

The present application claims priority of Japanese Patent Application No. 2022-071940 filed Apr. 25, 2022, the disclosure of which is hereby incorporated by reference.

### BACKGROUND OF THE INVENTION

### Field of the Invention

The present invention relates to a power conversion device, and more particularly, it relates to a power conversion device including a current sensor.

### Description of the Background Art

A power conversion device including a current sensor is disclosed in general. Such a power conversion device is disclosed in Japanese Patent Laid-Open No. 2020-058108, for example.

An inverter unit (power conversion device) described in Japanese Patent Laid-Open No. 2020-058108 is provided in a motor unit. The motor unit includes the inverter unit and a main body including a motor and a motor housing that houses the motor. The inverter unit is attached to the main body. The inverter unit includes an inverter and an inverter case that houses the inverter. The inverter unit includes bus bars connected to the inverter and protruding downward (main body side) from the inverter case. The bus bars protruding from the inverter case are connected to bus bars connected to a coil of the motor at connections located inside the motor housing. Although not clearly described in Japanese Patent Laid-Open No. 2020-058108, a terminal block (a base for connecting the bus bars to each other) for connecting the bus bars of the inverter to the bus bars of the motor is conceivably provided inside the motor housing separately from the other members of the motor.

In the inverter unit (power conversion device) described in Japanese Patent Laid-Open No. 2020-058108, as described above, the terminal block (the base for connecting the bus bars to each other) for connecting the bus bars of the inverter to the bus bars of the motor is conceivably provided inside the motor housing separately from the other components of the motor. Therefore, the size of the motor housing is increased by the size of the terminal block. In this case, the size of the motor unit including the inverter unit and the main body that includes the motor housing is disadvantageously increased.

### SUMMARY OF THE INVENTION

The present invention has been proposed in order to solve the aforementioned problems, and an object of the present invention is to provide a power conversion device capable of reducing or preventing an increase in the size of a motor unit.

In order to attain the aforementioned object, a power conversion device according to an aspect of the present invention is to be attached to a motor, and includes a power converter; a power converter housing to house the power converter; an output terminal connected to the power converter, to be connected to a power wiring of the motor, and to output power from the power converter to the motor; a current sensor to detect a current flowing through the output terminal; and a terminal block on which the output terminal is arranged and at which the output terminal and the power wiring are connected to each other. The current sensor includes a current sensor main body and a current sensor housing to house the current sensor main body, and the terminal block is provided on the current sensor housing. The terminal block is a base at which the power wiring of the motor and the output terminal are connected to each other.

In the power conversion device according to this aspect of the present invention, as described above, the terminal block on which the output terminal is arranged and at which the output terminal and the power wiring are connected to each other is provided on the current sensor housing. Accordingly, as compared with a case in which the terminal block is spaced apart from the current sensor, a space around the terminal block can be decreased due to at least no space between the terminal block and the current sensor housing. Consequently, even when the terminal block is provided in the power conversion device, an increase in the size of the power conversion device can be reduced or prevented. Furthermore, the motor does not include a terminal block, and thus the size of the motor can be reduced as compared with a case in which the motor includes a terminal block. Thus, an increase in the size of a unit (motor unit) including the power conversion device and the motor can be reduced or prevented.

In the power conversion device according to this aspect, the terminal block is preferably integrally formed with the current sensor housing by resin molding. Accordingly, as compared with a case in which the terminal block is formed separately from the current sensor housing, the number of components can be reduced, and the structure of the power conversion device can be simplified. Moreover, the terminal block can be firmly fixed to the current sensor housing.

In the power conversion device according to this aspect, the power converter housing preferably includes an insertion hole through which the power wiring of the motor is inserted into the power converter housing. Accordingly, the power wiring of the motor can be easily inserted into the power converter housing through the insertion hole.

In the power conversion device according to this aspect, the power converter housing preferably includes an opening to expose a connection of the output terminal to which the power wiring of the motor is connected at the terminal block. Accordingly, an operation to connect the power wiring of the motor to the output terminal at the terminal block can be performed through the opening. Furthermore, the connection state between the power wiring of the motor and the output terminal at the terminal block can be confirmed (visually recognized) through the opening.

In the power conversion device according to this aspect, the power converter preferably includes a switch including a plurality of switching elements, and a connection terminal provided on a first surface side of the current sensor housing to connect the switch to a first end of the output terminal, the terminal block is preferably provided on a second surface side, which is a backside of the first surface side of the current sensor housing, and the power wiring of the motor and a second end of the output terminal are preferably connected to each other at the terminal block. Accordingly, the connection terminal and the power wiring of the motor are provided on different surfaces, and thus mutual interference between the connection terminal and the power wiring of the motor can be reduced or prevented.

The power conversion device according to this aspect preferably further includes a fastening member to fasten the power wiring of the motor and the output terminal at the terminal block, the terminal block preferably includes a hole through which the power wiring of the motor passes, and a clearance formed between the power wiring and an inner peripheral surface of the hole when the power wiring passes through the hole preferably has a size smaller than a size of a head of the fastening member. Accordingly, dropping of the fastening member from the terminal block through the hole to the motor side can be reduced or prevented.

In the power conversion device according to this aspect, the output terminal is preferably provided for each of a plurality of phases, the output terminals of the plurality of phases are preferably aligned adjacent to each other on the terminal block, and the terminal block preferably includes walls to insulate the output terminals from each other between the output terminals adjacent to each other. Accordingly, the output terminals of different phases can be easily insulated from each other by the walls.

In the power conversion device according to this aspect, the output terminal preferably includes a bus bar having a flat plate shape. Accordingly, the output terminal can be easily arranged along the surface of the terminal block.

The power conversion device according to this aspect preferably further includes a control board configured or programmed to control the power converter, the power converter preferably includes a film capacitor to smooth DC power externally supplied and including a capacitor element and a resin mold portion to cover the capacitor element, and a wire to connect at least one of a positive electrode and a negative electrode of the capacitor element to the control board, and the wire is preferably pulled out from an inside of the resin mold portion to an outside of the resin mold portion. Accordingly, the wire is pulled out from the inside of the resin mold portion to the outside of the resin mold portion such that as compared with a case in which a bus bar is pulled out from the resin mold portion and is connected to the control board by the wire, due to omission of the bus bar, the number of components can be reduced, and an increase in the size of the power conversion device can be further reduced or prevented.

In this case, the power converter preferably includes a protective tube to cover at least a vicinity of a portion of the wire pulled out from the resin mold portion to relieve a stress applied to the wire. Accordingly, a break in the portion due to a stress applied to the portion of the wire pulled out from the resin mold portion can be significantly reduced or prevented by the protective tube.

In the power conversion device in which the wire is pulled out from the inside of the resin mold portion to the outside of the resin mold portion, the power converter preferably includes a switch including a plurality of switching elements, the control board is preferably connected to one of the positive electrode and the negative electrode of the capacitor element by the wire, and the switch preferably includes control pins protruding from the plurality of switching elements toward the control board and connected to the control board. Accordingly, the switching elements are connected to the control board by the control pins such that the number of wires can be reduced as compared with a case in which the switching elements are connected to the control board by wires.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view showing the configuration of a power conversion device according to an embodiment;

FIG. 2 is a perspective view showing the configurations of a current sensor and a terminal block according to the embodiment;

FIG. 3 is a front view showing the configurations of the current sensor and the terminal block according to the embodiment;

FIG. 4 is a sectional view taken along the line IV-IV in FIG. 3;

FIG. 5 is a plan view showing the configuration of a hole of the terminal block according to the embodiment;

FIG. 6 is a bottom view showing a power converter housing according to the embodiment, as viewed from the Z2 side;

FIG. 7 is a plan view showing an opening of the power converter housing according to the embodiment;

FIG. 8 is a plan view showing the configurations of a control board and a film capacitor according to the embodiment;

FIG. 9 is a schematic sectional view taken along the line IX-IX in FIG. 8;

FIG. 10 is a partially enlarged view of the vicinity of a notch of a fixing plate in FIG. 8; and

FIG. 11 is a sectional view taken along the line XI-XI in FIG. 8.

### DESCRIPTION OF THE PREFERRED EMBODIMENTS

An embodiment of the present invention is hereinafter described with reference to the drawings.

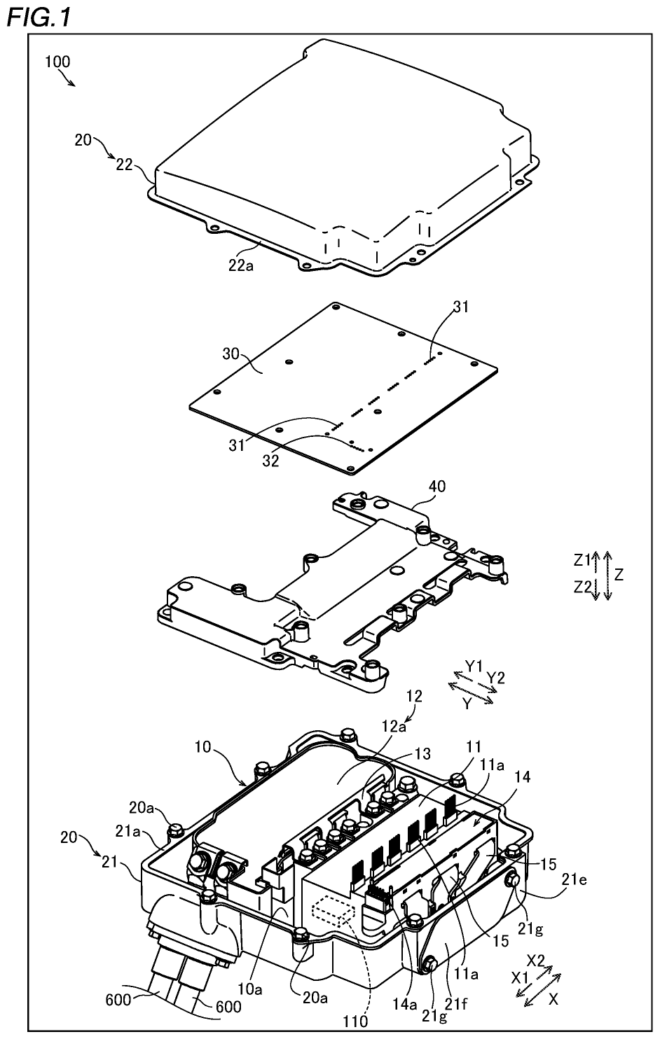

The configuration of a power conversion device 100 according to this embodiment is now described with reference to FIGS. 1 to 11. In this description, one direction in a plane on which an arrangement surface 10a (see FIG. 1) of a power converter 10 described below extends is defined as an X direction (an X1 direction and an X2 direction), a direction perpendicular to the X direction in the plane is defined as a Y direction (a Y1 direction and a Y2 direction), and a direction perpendicular to the arrangement surface 10a is defined as a Z direction (a Z1 direction and a Z2 direction).

### Configuration of Power Conversion Device

The power conversion device 100 is attached to a motor 200 (see FIG. 7). The motor 200 is an in-vehicle motor, for example. A motor unit 210 (see FIG. 7) includes the power conversion device 100 and the motor 200.

As shown in FIG. 1, the power conversion device 100 includes the power converter 10. The power converter 10 is an inverter. The power conversion device 100 also includes a power converter housing 20 that houses the power converter 10. The power converter housing 20 is attached to the motor 200 (see FIG. 7). The power converter housing 20 has a rectangular shape as viewed in a direction (Z direction) perpendicular to the arrangement surface 10a on which the power converter 10 is arranged.

The power converter 10 includes a switch 11 including a plurality of switching elements 110. In FIG. 1, only one switching element 110 is shown for the sake of simplification. The power converter 10 also includes a film capacitor 12 that smooths DC power supplied from the outside. DC power is supplied to the film capacitor 12 from an external high-voltage battery (not shown) via power wirings 600.

The film capacitor 12 is provided adjacent to the switch 11 on the Y1 side of the switch 11. The film capacitor 12 has a rectangular shape as viewed in the Z direction. The film capacitor 12 includes a resin mold portion 12a and a capacitor element 12b (see FIG. 9) molded into (covered with) the resin mold portion 12a. The resin mold portion 12a is made of an insulating resin member. For example, the resin mold portion 12a is made of an epoxy resin.

The power converter 10 includes a connection conductor 13 that connects the switch 11 to the film capacitor 12. The connection conductor 13 is provided between the film capacitor 12 and the switch 11 aligned in the Y direction.

The power conversion device 100 also includes a current sensor 14 that detects a current flowing from the switch 11 to the motor 200. The current sensor 14 is provided on the Y2 side of the switch 11. The current sensor 14 detects currents flowing through output terminals 15 described below. The current sensor 14 is described in detail below.

The power converter housing 20 includes a concave housing main body 21 recessed toward the Z2 side. The switch 11, the film capacitor 12, the current sensor 14, etc. are arranged (housed) in the housing main body 21.

The power converter housing 20 includes a cover 22 that covers the housing main body 21 from the Z1 side. The cover 22 is attachable to and detachable from the housing main body 21. Specifically, the cover 22 is fixed to the housing main body 21 by being fastened to the housing main body 21 with a plurality of screws 20a. The power converter 10 is housed in the power converter housing 20 while the cover 22 is fixed to the housing main body 21.

The cover 22 is fixed to the housing main body 21 while contacting an end 21a of the housing main body 21 on the cover 22 side (Z1 side). Specifically, the cover 22 and the housing main body 21 are screw-fastened to each other while an end 22a of the cover 22 on the housing main body 21 side (Z2 side) and the end 21a of the housing main body 21 contact each other.

The power conversion device 100 includes a control board 30 that controls the power converter 10. The control board 30 controls the switch 11 based on a detected value received from the current sensor 14. The control board 30 covers the film capacitor 12, the switch 11, the current sensor 14, etc. from the Z1 side.

The control board 30 includes insertion holes 31 into which control pins 11a of the switch 11 extending along the Z direction are inserted. The control pins 11a are fixed (connected) to the control board 30 by being soldered to the insertion holes 31 while the control pins 11a are inserted into the insertion holes 31. The control board 30 also includes insertion holes 32 into which current sensor pins 14a of the current sensor 14 extending along the Z direction are inserted. The current sensor pins 14a are fixed (connected) to the control board 30 by being soldered to the control board 30 by a solder 32a (see FIG. 11) while the vicinities of first ends 14b (see FIG. 11) of the current sensor pins 14a are inserted into the insertion holes 32.

The power converter 10 includes a fixing plate 40 that fixes the control board 30. The fixing plate 40 is interposed between the control board 30 and the power converter 10. The fixing plate 40 is made of an insulating resin member. For example, the fixing plate 40 is made of polyphenylene sulfide (PPS).

The power conversion device 100 includes the output terminals 15 connected to the power converter 10 (switch 11). The output terminals 15 are connected to power wirings 201 (see FIG. 3) of the motor 200. The output terminal 15 is provided for each of a plurality of phases (a U-phase, a V-phase, and a W-phase).

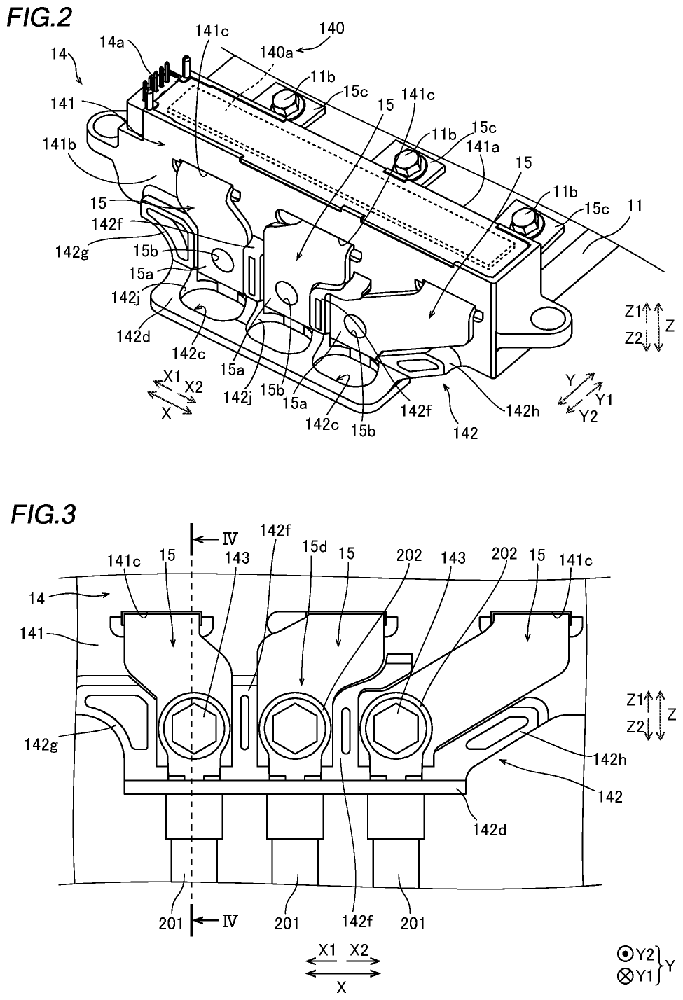

In this embodiment, the output terminals 15 include bus bars each having a flat plate shape. The output terminals 15 including the bus bars extend along a current sensor housing 141 (second surface 141b; see FIG. 2) (described below) of the current sensor 14.

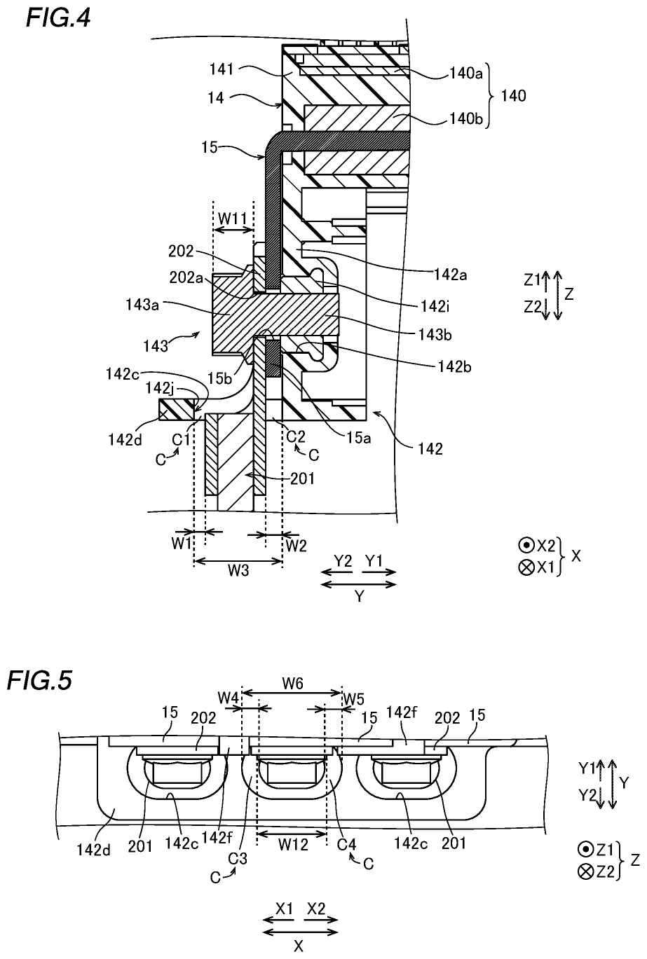

As shown in FIG. 2, the current sensor 14 includes a current sensor main body 140 and the current sensor housing 141 that houses the current sensor main body 140. The current sensor main body 140 includes a sensor board 140a that controls the current sensor 14 and a core 140b (see FIG. 4) that detects the currents flowing through the output terminals 15. A controller (CPU) (not shown) is mounted on the sensor board 140a. The output terminals 15 pass through the core 140b inside the current sensor housing 141 (see FIG. 4). In FIG. 2, illustration of screw members 143 described below and the power wirings 201 is omitted for the sake of simplification.

The power conversion device 100 also includes a terminal block 142 on which the output terminals 15 are arranged and at which the output terminals 15 and the power wirings 201 are connected to each other. The terminal block 142 refers to a base for connecting the output terminals 15 to the power wirings 201.

In this embodiment, the terminal block 142 is provided on the current sensor housing 141. That is, as shown in FIG. 3, the power wirings 201 extend from the motor 200 side to the inside of the power converter housing 20, and are connected to the output terminals 15 at the terminal block 142 inside the power converter housing 20.

In this embodiment, as shown in FIG. 2, the terminal block 142 is integrally formed with the current sensor housing 141 by resin molding. That is, the terminal block 142 is connected to the current sensor housing 141 without using a fastening member or the like. The current sensor housing 141 and the terminal block 142 are made of PPS, for example.

Specifically, as shown in FIG. 4, the terminal block 142 includes a base 142a (second surface 141b) corresponding to a base at which the output terminals 15 and the power wirings 201 are connected to each other. The base 142a extends in the Z2 direction from the current sensor housing 141. The power conversion device 100 also includes the screw members 143 that fasten the power wirings 201 of the motor 200 and the output terminals 15 at the terminal block 142 (base 142a). The base 142a includes insertion holes 142b into which the screw members 143 are inserted. Nuts 142i are provided in the insertion holes 142b. The screw members 143 are examples of a “fastening member” in the claims.

Through-holes 15b are provided in the vicinity of ends 15a of the output terminals 15 on the terminal block 142 side. The power wirings 201 include crimp terminals 202. The crimp terminals 202 include through-holes 202a. The screw members 143 are inserted through the through-holes 15b of the output terminals 15 and the through-holes 202a of the crimp terminals 202 of the power wirings 201 into the insertion holes 142b. Thus, the output terminals 15 and the power wirings 201 are connected (fastened) by the screw members 143 at the terminal block 142 (base 142a). The ends 15a are examples of a “second end” in the claims.

As shown in FIG. 2, the terminal block 142 includes holes 142c through which the power wirings 201 (see FIG. 3) of the motor 200 pass. Three holes 142c are provided so as to correspond to the power wirings 201 of a plurality of phases. The terminal block 142 also includes a stopper 142d extending from a Z2-side end of the base 142a (see FIG. 4) to the Y2 side. The three holes 142c are provided in the stopper 142d. The stopper 142d is provided to prevent the screw members 143 (see FIG. 3) from dropping to the motor 200. The holes 142c each have an elliptical shape as viewed in the Z direction.

The power conversion device 100 also includes connection terminals 11b that connect the switch 11 to ends 15c of the output terminals 15. The connection terminals 11b are electrically connected to the switching elements 110 (see FIG. 1) of the switch 11. The connection terminals 11b are provided on the first surface 141a side of the current sensor housing 141. The ends 15c are examples of a “first end” in the claims.

In this embodiment, the terminal block 142 to which the power wirings 201 of the motor 200 and the ends 15a of the output terminals 15 are connected is provided on the second surface 141b side, which is the backside of a first surface 141a of the current sensor housing 141. That is, the terminal block 142 provided on the second surface 141b side and the connection terminals 11b provided on the first surface 141a side are separated from each other by the current sensor housing 141.

The current sensor housing 141 includes through-holes 141c through which the output terminals 15 pass. Three through-holes 141c are provided so as to correspond to the output terminals 15 of a plurality of phases. The three through-holes 141c are aligned along the X direction.

The output terminals 15 of the plurality of phases (three phases in this embodiment) are aligned adjacent to each other on the terminal block 142. Specifically, the output terminals 15 (ends 15a) of the plurality of phases are aligned along the X direction on the terminal block 142 (base 142a).

In this embodiment, the terminal block 142 includes walls 142f that insulate the output terminals 15 to each other between the output terminals 15 adjacent to each other. Specifically, the walls 142f separate the output terminals 15 (ends 15a) adjacent to each other in the X direction from each other. The walls 142f protrude from the base 142a (see FIG. 4) to the Y2 side. The walls 142f protrude to the Y2 side relative to the output terminals 15.

The terminal block 142 includes a wall 142g arranged along the output terminals 15 on the X1 side of the output terminal 15 on the most X1 side. Moreover, the terminal block 142 includes a wall 142h arranged along the output terminals 15 on the X2 side of the output terminal 15 on the most X2 side.

As shown in FIG. 4, each of the screw members 143 includes a head 143a and a leg 143b. The leg 143b is fitted into the nut 142i of the insertion hole 142b.

In this embodiment, the size of a clearance C formed between the power wiring 201 and the inner peripheral surface 142j of the hole 142c when the power wiring 201 passes through the hole 142c is smaller than the size of the head 143a of the screw member 143. Specifically, the clearance C includes a clearance C1 formed on the Y2 side of the power wiring 201 and a clearance C2 formed on the Y2 side of the power wiring 201. Each of the width W1 of the clearance C1 in the Y direction and the width W2 of the clearance C2 in the Y direction is about 2 mm, for example. On the other hand, the width W11 of the head 143a of the screw member 143 in the Y direction is 7 mm, for example. The width W3 of the hole 142c in the Y direction is about 13 mm, for example.

As shown in FIG. 5, the clearance C includes a clearance C3 formed on the X1 side of the power wiring 201 and a clearance C4 formed on the X2 side of the power wiring 201. Each of the width W4 of the clearance C3 in the X direction and the width W5 of the clearance C4 in the X direction is about 3 mm, for example. On the other hand, the width W12 of the head 143a of the screw member 143 in the X direction is 17 mm, for example. The width W6 of the hole 142c in the X direction is about 21 mm, for example.

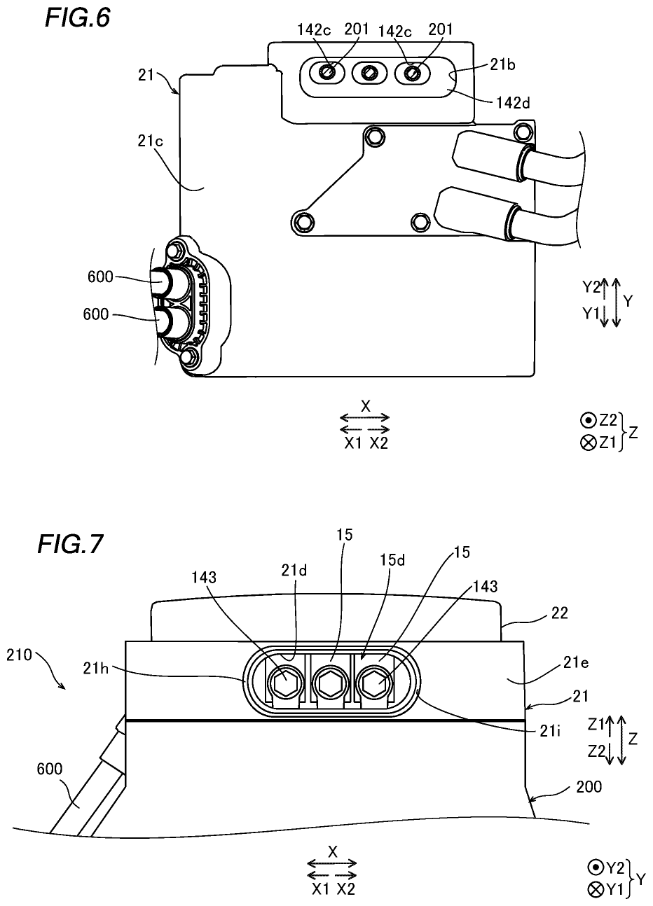

In this embodiment, as shown in FIG. 6, the power converter housing 20 includes an insertion hole 21b through which the power wirings 201 of the motor 200 are inserted into the power converter housing 20. Specifically, the insertion hole 21b is provided in the bottom surface 21c of the housing main body 21.

Specifically, the insertion hole 21b overlaps the stopper 142d and the holes 142c of the stopper 142d as viewed from the Z2 direction side. Each of the three holes 142c is surrounded by the inner peripheral edge of the insertion hole 21b as viewed from the Z2 direction side. Only one insertion hole 21b is provided in the bottom surface 21c. The insertion hole 21b has a rectangular shape (elliptical shape) extending along the X direction in which the three holes 142c are aligned, as viewed from the Z2 direction side. That is, the long side of the insertion hole 21b extends along the X direction. In FIG. 6, illustration of the output terminals 15 and the screw members 143 is omitted for the sake of simplification.

In this embodiment, as shown in FIG. 7, the power converter housing 20 includes an opening 21d to expose connections 15d of the output terminals 15 to which the power wirings 201 of the motor 200 are connected at the terminal block 142. Specifically, the opening 21d is provided in the side surface 21e of the housing main body 21. The side surface 21e extends along the Z direction.

Specifically, the connections 15d overlap the opening 21d as viewed from the Y2 direction side. The connections 15d are surrounded by the inner peripheral edge of the opening 21d as viewed from the Y2 direction side.

The opening 21d is covered with a side cover 21f (see FIG. 1) that is attachable to and detachable from the side surface 21e. The connections 15d are not exposed when the opening 21d is covered with the side cover 21f. The side cover 21f is fastened to the side surface 21e with screw members 21g (see FIG. 1).

As shown in FIG. 7, the power conversion device 100 includes an O-ring 21h that surrounds the opening 21d. The O-ring 21h is fitted into a recess 21i that surrounds the opening 21d. The O-ring 21h is provided as a seal member between the side surface 21e and the side cover 21f. The O-ring 21h is made of rubber, for example.

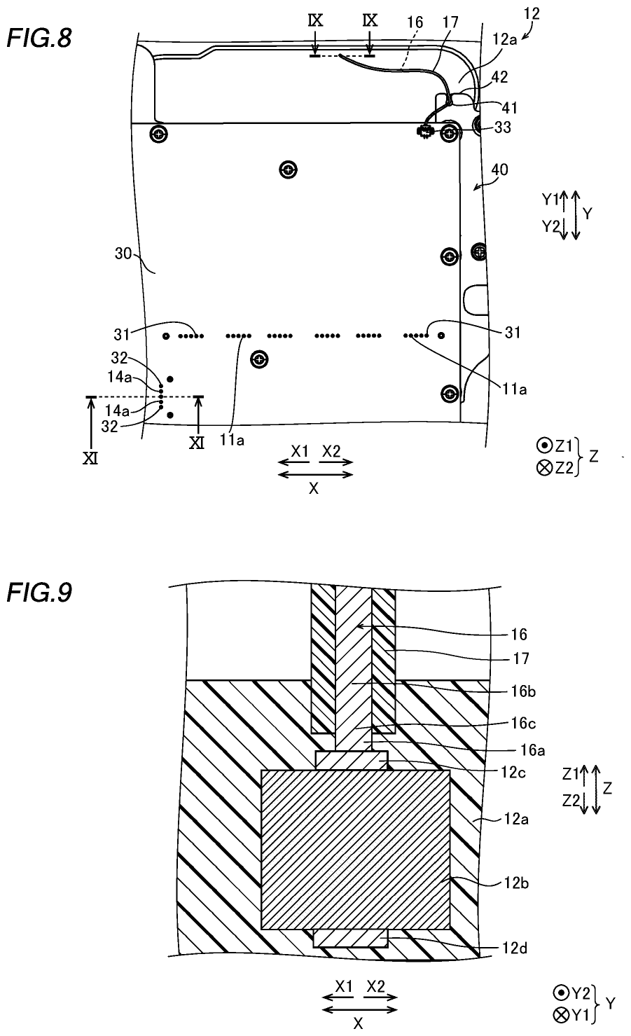

As shown in FIG. 8, the power converter 10 includes a wire 16 that connects the film capacitor 12 to the control board 30. Specifically, the wire 16 connects a positive electrode 12c (see FIG. 9) of the capacitor element 12b in the film capacitor 12 to the control board 30. The wire 16 is connected to the control board 30 by a connector 33 provided on the control board 30. The positive electrode 12c (see FIG. 9) of the capacitor element 12b is connected to the control board 30 by the wire 16 such that a positive voltage value of the capacitor element 12b (power converter 10) is transmitted to the control board 30. The wire 16 is not connected to a negative electrode 12d of the capacitor element 12b. FIG. 9 is a schematic view, and the arrangement of the capacitor element 12b, the positive electrode 12c, the negative electrode 12d, etc. may differ from the actual arrangement.

In this embodiment, the wire 16 is pulled out from the inside of the resin mold portion 12a to the outside of the resin mold portion 12a. That is, an end 16a (see FIG. 9) of the wire 16 on the capacitor element 12b side (the side opposite to the connector 33) is molded into the resin mold portion 12a.

In this embodiment, the power converter 10 includes a protective tube 17 covering at least the vicinity of a portion 16b of the wire 16 pulled out from the resin mold portion 12a to relieve a stress applied to the wire 16. Specifically, the protective tube 17 covers from a portion 16c of the wire 16 in the vicinity of the end 16a in the resin mold portion 12a to a portion (not numbered) of the wire 16 in the vicinity of the connector 33. That is, the protective tube 17 covers substantially the entire wire 16 exposed from the resin mold portion 12a. Thus, a break in the wire 16 can be reduced or prevented when another member contacts the wire 16. The protective tube 17 is made of a silicon resin, for example. That is, the protective tube 17 is flexible. Moreover, the protective tube 17 is insulating.

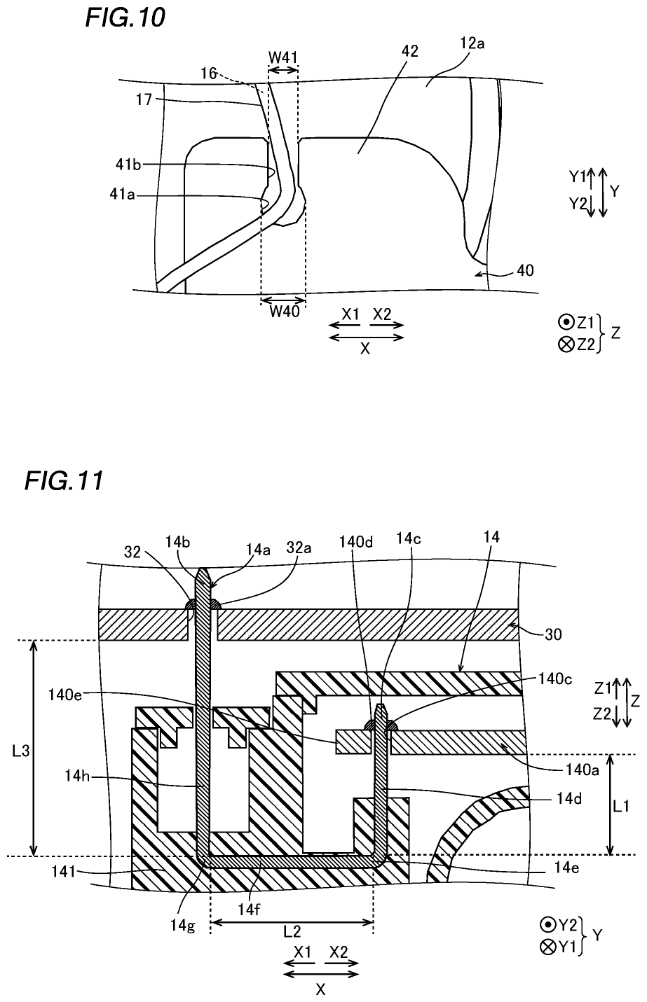

The fixing plate 40 includes a notch 41 with which the wire 16 engages. As shown in FIG. 10, the notch 41 includes a positioning portion 41a having a substantially circular shape as viewed from the Z1 direction side, in which the wire 16 is positioned. The notch 41 also includes a linear guiding portion 41b as viewed from the Z1 direction side to guide the wire 16 to the positioning portion 41a. The positioning portion 41a and the guiding portion 41b are continuous with each other.

The maximum width W40 of the positioning portion 41a in the X direction is larger than the width W41 of the guiding portion 41b in the X direction as viewed from the Z1 direction side. The guiding portion 41b extends along the Y direction. The notch 41 is provided at an end 42 of the fixing plate 40 on the Y1 side.

In this embodiment, as shown in FIG. 8, the control board 30 is connected to the positive electrode 12c (see FIG. 9) of the capacitor element 12b by the wire 16, and the control pins 11a protruding from the switching elements 110 toward the control board 30 are connected to the control board 3. The switching elements 110 are connected to the control board 30 via the control pins 11a such that a negative voltage value of the capacitor element 12b (power converter 10) is transmitted to the control board 30.

As shown in FIG. 11, the current sensor pins 14a are connected to the sensor board 140a in the current sensor housing 141. Specifically, the current sensor pins 14a are fixed (connected) to the sensor board 140a by being soldered to the sensor board 140a by a solder 140d while the vicinities of second ends 14c of the current sensor pins 14a are inserted into insertion holes 140c of the sensor board 140a. The sensor board 140a and the control board 30 are connected to each other by the current sensor pins 14a, and thus the size of the power converter 10 can be reduced as compared with a case in which the sensor board 140a and the control board 30 are connected to each other via a wire and connectors.

Each of the current sensor pins 14a has a folded shape extending from the sensor board 140a to the side (Z2 side) opposite to the control board 30 and then folded back toward the control board 30. Specifically, each of the current sensor pins 14a has a J-shape as viewed in the Y direction.

Specifically, each of the current sensor pins 14a includes a first portion 14d extending from the sensor board 140a to the side opposite to the control board 30 along the Z direction. Each of the current sensor pins 14a also includes a second portion 14f connected to an end 14e of the first portion 14d opposite to the sensor board 140a and extending along the X direction perpendicular to the first portion 14d. Each of the current sensor pins 14a also includes a third portion 14h connected to an end 14g of the second portion 14f opposite to the end 14e and extending along the Z direction toward the control board 30.

The entire second portion 14f is molded into the current sensor housing 141. A portion of the first portion 14d on the end 14e side is molded into the current sensor housing 141. A portion of the third portion 14h on the end 14g side is molded into the current sensor housing 141.

The insertion holes 140c of the sensor board 140a are provided in the vicinity of the outer peripheral edge 140e of the sensor board 140a.

The first portion 14d has a length L1. The second portion 14f has a length L2. The third portion 14h has a length L3. The length L3 is larger than the length L1. The length L3 is about twice the length L1. The length L2 is larger than the length L1 and smaller than the length L3.

### Advantageous Effects of This Embodiment

According to this embodiment, the following advantageous effects are achieved.

According to this embodiment, as described above, in the power conversion device 100, the terminal block 142 is provided on the current sensor housing 141. Accordingly, as compared with a case in which the terminal block 142 is spaced apart from the current sensor 14, a space around the terminal block 142 can be decreased due to at least no space between the terminal block 142 and the current sensor housing 141. Consequently, even when the terminal block 142 is provided in the power conversion device 100, an increase in the size of the power conversion device 100 can be reduced or prevented. Furthermore, the motor 200 does not include a terminal block, and thus the size of the motor 200 can be reduced as compared with a case in which the motor 200 includes a terminal block. Thus, an increase in the size of the motor unit 210 including the power conversion device 100 and the motor 200 can be reduced or prevented.

According to this embodiment, as described above, in the power conversion device 100, the terminal block 142 is integrally formed with the current sensor housing 141 by resin molding. Accordingly, as compared with a case in which the terminal block 142 is formed separately from the current sensor housing 141, the number of components can be reduced, and the structure of the power conversion device 100 can be simplified. Moreover, the terminal block 142 can be firmly fixed to the current sensor housing 141.

According to this embodiment, as described above, in the power conversion device 100, the power converter housing 20 includes the insertion hole 21b through which the power wirings 201 of the motor 200 are inserted into the power converter housing 20. Accordingly, the power wirings 201 of the motor 200 can be easily inserted into the power converter housing 20 through the insertion hole 21b.

According to this embodiment, as described above, in the power conversion device 100, the power converter housing 20 includes the opening 21d to expose the connections 15d of the output terminals 15 to which the power wirings 201 of the motor 200 are connected at the terminal block 142. Accordingly, an operation to connect the power wirings 201 of the motor 200 to the output terminals 15 at the terminal block 142 can be performed through the opening 21d. Furthermore, the connection state between the power wirings 201 of the motor 200 and the output terminals 15 at the terminal block 142 can be confirmed (visually recognized) through the opening 21d.

According to this embodiment, as described above, in the power conversion device 100, the power converter 10 includes the connection terminals 11b provided on the first surface 141a side of the current sensor housing 141, and the terminal block 142 is provided on the second surface 141b side, which is the backside of the first surface 141a of the current sensor housing 141. Accordingly, the connection terminals 11b and the power wirings 201 of the motor 200 are provided on different surfaces, and thus mutual interference between the connection terminals 11b and the power wirings 201 of the motor 200 can be reduced or prevented.

According to this embodiment, as described above, in the power conversion device 100, the size of the clearance C formed between the power wiring 201 and the inner peripheral surface 142j of the hole 142c when the power wiring 201 passes through the hole 142c is smaller than the size of the head 143a of the screw member 143. Accordingly, dropping of the screw member 143 from the terminal block 142 through the hole 142c to the motor 200 can be reduced or prevented.

According to this embodiment, as described above, in the power conversion device 100, the terminal block 142 includes the walls 142f to insulate the output terminals 15 from each other between the output terminals 15 adjacent to each other. Accordingly, the output terminals 15 of different phases can be easily insulated from each other by the walls 142f.

According to this embodiment, as described above, in the power conversion device 100, the output terminals 15 include the bus bars each having a flat plate shape. Accordingly, the output terminals 15 can be easily arranged along the surface (second surface 141b) of the terminal block 142.

According to this embodiment, as described above, in the power conversion device 100, the wire 16 is pulled out from the inside of the resin mold portion 12a to the outside of the resin mold portion 12a. Accordingly, the wire 16 is pulled out from the inside of the resin mold portion 12a to the outside of the resin mold portion 12a such that as compared with a case in which a bus bar is pulled out from the resin mold portion 12a and is connected to the control board 30 by the wire 16, due to omission of the bus bar, the number of components can be reduced, and an increase in the size of the power conversion device 100 can be further reduced or prevented.

According to this embodiment, as described above, in the power conversion device 100, the power converter 10 includes the protective tube 17 to cover at least the vicinity of the portion 16b of the wire 16 pulled out from the resin mold portion 12a to relieve a stress applied to the wire 16. Accordingly, a break in the portion 16b due to a stress applied to the portion 16b of the wire 16 pulled out from the resin mold portion 12a can be significantly reduced or prevented by the protective tube 17.

According to this embodiment, as described above, in the power conversion device 100, the control board 30 is connected to one of the positive electrode 12c and the negative electrode 12d of the capacitor element 12b by the wire 16, and the control pins 11a protruding from the switching elements 110 toward the control board 30 are connected to the control board 30. Accordingly, the switching elements 110 are connected to the control board 30 by the control pins 11a such that the number of wires 16 can be reduced as compared with a case in which the switching elements 110 are connected to the control board 30 by wires 16.

### MODIFIED EXAMPLES

The embodiment disclosed this time must be considered as illustrative in all points and not restrictive. The scope of the present invention is not shown by the above description of the embodiment but by the scope of claims for patent, and all modifications (modified examples) within the meaning and scope equivalent to the scope of claims for patent are further included.

For example, while the current sensor housing 141 and the terminal block 142 are integrally formed in the aforementioned embodiment, the present invention is not limited to this. For example, the current sensor housing 141 and the terminal block 142 may alternatively be formed separately from each other and be separable from each other.

While the connection terminals 11b that connect the switch 11 to the output terminals 15 are provided on the first surface 141a side opposite to the second surface 141b of the current sensor housing 141 on which the terminal block 142 is provided in the aforementioned embodiment, the present invention is not limited to this. For example, the connection terminals 11b and the terminal block 142 may alternatively be provided on surfaces of the current sensor housing 141 adjacent to each other.

While the terminal block 142 includes the walls 142f provided between the adjacent output terminals 15 in the aforementioned embodiment, the present invention is not limited to this. For example, the walls 142f may not be provided on the terminal block 142 as long as the adjacent output terminals 15 are spaced apart from each other by an insulation distance or more.

While the wire 16 is covered with the protective tube 17 in the aforementioned embodiment, the present invention is not limited to this. The wire 16 may not be covered with the protective tube 17. Furthermore, only the vicinity of the portion 16b of the wire 16 pulled out from the resin mold portion 12a may alternatively be covered with the protective tube 17.

While the positive electrode 12c of the capacitor element 12b is connected to the control board 30 by the wire 16 in the aforementioned embodiment, the present invention is not limited to this. The negative electrode 12d of the capacitor element 12b may alternatively be connected to the control board 30 by the wire 16. Furthermore, both the positive electrode 12c and the negative electrode 12d of the capacitor element 12b may alternatively be connected to the control board 30 by wires 16.

What is claimed is:

1. A power conversion device to be attached to a motor, the power conversion device comprising:
a power converter;
a power converter housing to house the power converter;
an output terminal connected to the power converter and configured to be connected to a power wiring of the motor, the output terminal being configured to output power from the power converter to the motor;
a current sensor to detect a current flowing through the output terminal; and
a terminal block on which the output terminal is arranged and at which the output terminal and the power wiring are connected to each other; wherein
the current sensor includes a current sensor main body and a current sensor housing to house the current sensor main body; and
the terminal block is provided on the current sensor housing.

2. The power conversion device according to claim 1, wherein the terminal block is integrally formed with the current sensor housing by resin molding.

3. The power conversion device according to claim 1, wherein the power converter housing includes an insertion hole through which the power wiring of the motor is configured to be inserted into the power converter housing.

4. The power conversion device according to claim 1, wherein the power converter housing includes an opening to expose a connection of the output terminal to which the power wiring of the motor is configured to be connected at the terminal block.

5. The power conversion device according to claim 1, wherein
the power converter includes a switch including a plurality of switching elements, and a connection terminal provided on a first surface side of the current sensor housing to connect the switch to a first end of the output terminal;
the terminal block is provided on a second surface side, which is a backside of the first surface side of the current sensor housing; and
the power wiring of the motor and a second end of the output terminal are configured to be connected to each other at the terminal block.

6. The power conversion device according to claim 1, further comprising:
a fastening member configured to fasten the power wiring of the motor and the output terminal at the terminal block; wherein
the terminal block includes a hole through which the power wiring of the motor is configured to pass; and
a clearance formed between the power wiring and an inner peripheral surface of the hole when the power wiring is configured to pass through the hole is configured to have a size smaller than a size of a head of the fastening member.

7. The power conversion device according to claim 1, wherein
the output terminal is provided for each of a plurality of phases;
the output terminals of the plurality of phases are aligned adjacent to each other on the terminal block; and
the terminal block includes walls to insulate the output terminals from each other between the output terminals adjacent to each other.

8. The power conversion device according to claim 1, wherein the output terminal includes a bus bar having a flat plate shape.

9. The power conversion device according to claim 1, further comprising:
a control board to control the power converter; wherein the power converter includes:
a film capacitor configured to smooth DC power externally supplied and including a capacitor element and a resin mold portion to cover the capacitor element; and
a wire to connect at least one of a positive electrode and a negative electrode of the capacitor element to the control board; and
the wire is pulled out from an inside of the resin mold portion to an outside of the resin mold portion.

10. The power conversion device according to claim 9, wherein the power converter includes a protective tube to cover at least a vicinity of a portion of the wire pulled out from the resin mold portion to relieve a stress applied to the wire.

11. The power conversion device according to claim 9, wherein
the power converter includes a switch including a plurality of switching elements;
the control board is connected to one of the positive electrode and the negative electrode of the capacitor element by the wire; and
the switch includes control pins protruding from the plurality of switching elements toward the control board and connected to the control board.
